(19) United States
(12) Patent Application Publication
(10) Pub. No.: US 2011/0250348 A1
(43) Pub. Date: Oct. 13, 2011

(54) METHODS OF MAKING CARBONACEOUS PARTICLES

(75) Inventors: Zhenhua MAO, Ponca City, OK (US); Chengtian Wu, Ponca City, OK (US)

(73) Assignee: ConocoPhillips Company, Houston, TX (US)

(21) Appl. No.: 13/083,162

(22) Filed: Apr. 8, 2011

Related U.S. Application Data
(60) Provisional application No. 61/322,066, filed on Apr. 8, 2010.

(51) Int. Cl. B05D 5/12; B02C 23/18

(52) U.S. Cl. 427/113; 427/122; 241/15

(57) ABSTRACT

Methods and apparatus relate to preparing particles for use as electrode material in batteries. Wet attrition milling provides the particles sized as desired. Pre-milling with a jet mill, for example, may occur prior to the wet attrition milling. Further, adding a soluble carbon-residue-forming material to a suspension before and/or after the wet attrition milling can facilitate the wet attrition milling and/or enable in-line coating via procedures causing precipitation of the carbon-residue-forming material onto the particles that are sized.

### CROSS-REFERENCE TO RELATED APPLICATIONS

This application is a non-provisional application which claims benefit under 35 USC §119(e) to U.S. Provisional Application Ser. No. 61/322,066 filed Apr. 8, 2010 entitled “METHODS OF MAKING CARBONACEOUS PARTICLES,” which is incorporated herein in its entirety.

### STATEMENT REGARDING FEDERALLY SPONSORED RESEARCH OR DEVELOPMENT

None

### FIELD OF THE INVENTION

Embodiments of the invention relate to production of battery materials.

### BACKGROUND OF THE INVENTION

Many electric powered devices rely on performance of batteries to achieve weight, power, and size criteria. Materials used for construction of electrodes in the batteries determine ability to meet requirements desired with respect to the performance. For example, various types of graphite powders often form anode material for lithium ion batteries. Carbon-containing coatings on core compositions that may be carbonaceous too or may be formed of compounds lacking carbon also provide some carbonaceous particles utilized in making batteries. Attributes of the carbonaceous particles influence the performance such that the properties desired are not achieved with prior techniques or necessitate complex and expensive manufacturing processes.

Therefore, a need exists for methods of making carbonaceous particles.

### SUMMARY OF THE INVENTION

In one embodiment, a method includes mixing solid battery material precursor with a liquid milling agent to form a suspension and agitating a dispersion of the suspension and particulate milling media in a mill to reduce particle size of the solid battery material precursor. Preparing a mixture by adding a solution of carbon-residue-forming material to the suspension output from the mill enables the carbon-residue-forming material to be precipitated within the mixture onto the solid battery material precursor as a coating prior to solid and liquid phase separation of the mixture to recover coated particles thereby produced. Heat treating the coated particles causes carbonization thereof to form desirable battery electrode material.

According to one embodiment, a method includes pre-milling coke material into intermediate coke particles, mixing the intermediate coke particles with xylene to form a suspension, and wet attrition milling the intermediate coke particles into sized coke particles by agitating a dispersion of the suspension and particulate milling media in a mill. Preparing a mixture by adding a solution of pitch dissolved in xylene to the suspension output from the mill enables precipitation of the pitch within the mixture as a coating onto the sized coke particles to occur by diluting concentration of the pitch upon mixing with the suspension and lowering temperature of the mixture from an initial temperature at which the solution and the suspension are combined. Separating solid and liquid phases of the mixture recovers coated particles that are produced by the precipitation and are heat treated to cause carbonization thereof to form desirable electrode material

For one embodiment, a method includes jet milling carbonaceous material to reduce particle size of the carbonaceous material, thereby providing intermediate sized product. In addition, mixing the intermediate sized product with a liquid milling agent and carbon-residue-forming hydrocarbon forms a suspension. The method further includes wet attrition milling the intermediate sized product by agitating a dispersion of the suspension and particulate milling media. Addition of an oxidizing agent into a resulting mixture causes precipitation of the carbon-residue-forming material within the mixture as a coating onto sized coke particles. Separating solid and liquid phases of the mixture recovers coated particles that are produced by the precipitation and are heat treated to cause carbonization thereof to form desirable electrode material.

### BRIEF DESCRIPTION OF THE DRAWINGS

The invention, together with further advantages thereof, may best be understood by reference to the following description taken in conjunction with the accompanying drawings.

FIG. 1 is a flow chart illustrating a method of preparing particles for use in batteries, according to one embodiment of the invention.

FIG. 2 is a graph illustrating particle size distribution of a battery powder post jet milling alone and after subsequent wet attrition milling, according to one embodiment of the invention.

FIG. 3 is a plot showing different relative influences on average and tenth percentile particle dimensions due to agitation speed during milling, according to one embodiment of the invention.

### DETAILED DESCRIPTION OF THE INVENTION

Embodiments of the invention relate to preparing precursor particles for use as electrode material in batteries, such as lithium ion batteries. Wet attrition milling with a milling agent provides the particles sized as desired in a slurry that can directly be used in subsequent processing steps to form desirable material. Pre-milling with a jet mill, for example, may occur prior to the wet attrition milling. Further, adding a soluble carbon-residue-forming material to a suspension before and/or after the wet attrition milling can facilitate the wet attrition milling and/or enable in-line coating via procedures causing precipitation of the carbon-residue-forming material onto the particles that are sized.

Examples of the precursor particles include carbonaceous material, carbonaceous material with carbon-containing coatings, silicon and lithium alloying metals, and lithium metal oxides and polyanionic material, such as lithium vanadium phosphate, with carbon-containing coatings. Exemplary sources of the carbonaceous material include pitches, petroleum and coal tar cokes, synthetic graphite, natural graphite, and compounds derived from organic and natural polymers. Thus, the carbonaceous materials may be either graphitic or form graphite on heating to graphitization temperatures of 2200° C. or higher.

For some embodiments, solid precursor for the particles include the carbonaceous material, referenced herein for example even though the precursor may include other battery component materials, that forms cores of the particles, which may be provided with a fusible, carbon-residue-forming material as the carbon-containing coating on the solid precursor. For some embodiments, other (e.g., ceramic, metallic and combinations thereof) compositions that are not carbonaceous may make up the solid precursor onto which it is desirable to have a carbonaceous coating. Such applications include cathode materials where the solid precursor may include compositions of, for example, lithium metal oxide and lithium metal phosphate (e.g., lithium iron phosphate or lithium vanadium phosphate). Silicon or metal and metal alloys such as tin and tin alloys particulate may form the solid precursor in applications for preparing other anode materials.

Amount of the carbon-residue-forming material deposited on the precursor may vary since the amount depends in part on factors including the uniformity of the coating and the specific form and surfaces of the precursor. Although the amount of coating may vary from as little as 1 weight percent (wt %) to as much as 50 wt %, expressed as percentage of the mass of the coating relative to total mass of the coated particles as measured by weighing the dry particles before and after coating, the amount of coating in some embodiments ranges from about 2.5 wt % to about 25 wt % or from about 5 wt % to about 20 wt %. In some embodiments, compositions which can be reacted with an oxidizing agent provide the carbon-residue-forming material for use as the coating. Examples of the carbon-residue-forming materials include aromatic residues from petroleum pitches, chemical process pitches, lignin from pulp industry, phenolic resins, and carbohydrate materials such as sugars and polysaccharides. The carbon-residue-forming material may be any material that forms a residue which is “substantially carbon” when oxidized and then thermally reacted in an inert atmosphere to a carbonization temperature of at least 850° C. As used herein, “substantially carbon” indicates that the residue is at least 90% by wt. carbon, or at least 95% by wt. carbon. The carbon-residue-forming material may form at least 10%, at least 40%, or at least 60% carbon residue on carbonization, based on original mass of the carbon-residue-forming material.

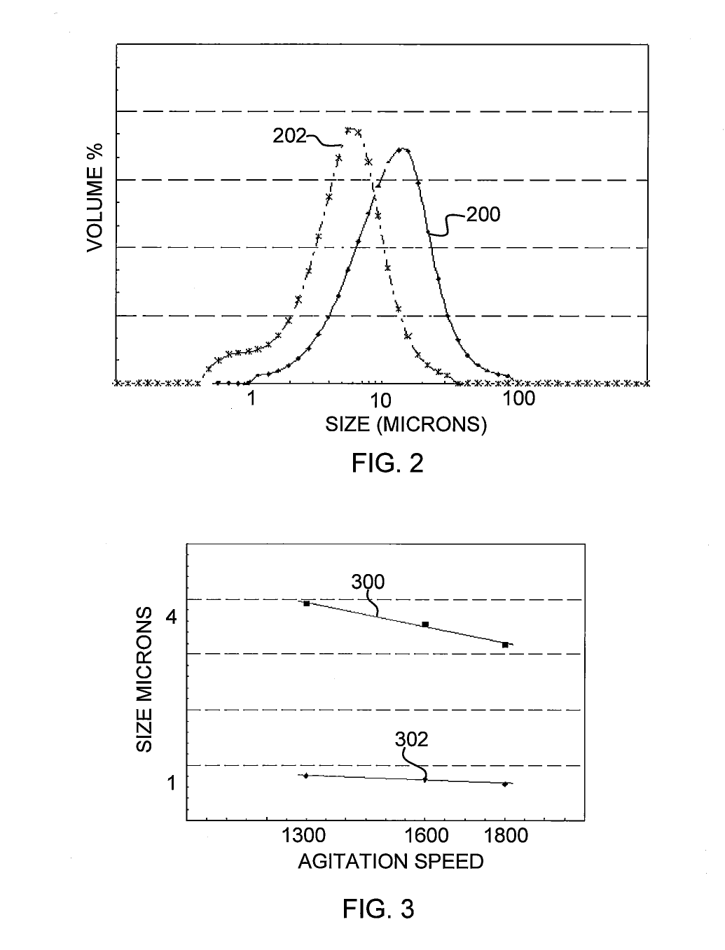

Techniques for reducing size of the solid precursor for the particles enable achieving suitable attributes for the particles while permitting the precipitation to occur in-line as described further herein. For some embodiments, pre-milling the precursor in a process different and prior to wet attrition milling results in achieving particle sizes (see, FIG. 2) suitable for use even without further size classification. The pre-milling may achieve an average particle size of less than about 200 microns, less than about 100 microns, or between about 10 and about 25 microns. Impact milling and/or non-mechanical milling, such as jet milling, provide examples of the pre-milling suitable for obtaining such average particle sizes. The wet attrition milling further reduces the average particle size from that provided by the pre-milling to less than about 10 microns or between about 3 microns and about 7 microns. In comparison to such dual milling, use of the jet milling alone to reduce size of the precursor tends to result in a broader particle size distribution, more particles below a minimum size threshold (e.g., 1.0 micron), and particles with a larger aspect ratio. The impact milling alone tends to result in agglomeration of the precursor prior to obtaining an average particle size as low as needed. Dry attrition milling also leads to the precursor agglomerating.

The wet attrition milling includes mixing the precursor with a liquid milling agent to form a suspension and agitating a dispersion of the suspension and particulate milling media in a mill to reduce the particle size of the precursor. In operation of the mill, the particulate milling media gains momentum in the suspension from rotation of a shaft and/or rotors of the mill and impacts one another and the precursor causing reduction in the particle size of the precursor. Examples of the milling media include yttrium-stabilized zirconium oxide, stainless steel, tungsten carbide, and other compounds hard relative to the precursor and with sufficient inertness to not contaminate the precursor from wear of the milling media. For some embodiments, examples of the liquid milling agent include suitable solvents for the carbon-residue-forming material.

The liquid milling agent in some embodiments further includes one or more milling enhancement additives that increase wet-ability of the precursor with the solvent. For example, a surfactant, such as sodium dodecyl sulfate, that is used as the additive influences wetting of the precursor when water is used as the solvent. The milling agent in some embodiments includes an organic compound or mixture different from the milling agent and soluble in the milling agent. When the solvent is organic, such as xylene, polar compounds, such as n-methyl pyrrolidinone, and pitch soluble in the xylene provide examples of the additive. Affinity of the pitch to coke used as the precursor aides in dispersing the coke during the wet attrition milling. The additive facilitates creating round-shaped particles with lower aspect ratio relative to more flat-shaped particles tending to be produced in absence of the additive. Rounded particle morphology offers elevated structural integrity, reduces BET surface area, and is believed to provide higher battery coulombic efficiency and lower heat evolution in battery use relative to the more flat-shaped particles. Introducing the additive also provides economic benefit by increasing milling efficiency and hence throughput of the wet milling.

In some embodiments, depositing the carbon-residue-forming material occurs once the precursor is sized. A solution utilized in performing deposition of the coating contains the carbon-residue-forming material dissolved in the solvent. The solvent selected for use in the solution of carbon-residue-forming material and the solvent selected to prepare the suspension during the wet attrition milling can be alike or different and still enable precipitation as described herein. Examples of the solvents include pure organic compounds or a combination of different solvents with choice of the solvents depending on the carbon-residue-forming material used. For example, the solvents for dissolving the carbon-residue-forming material include one or more of benzene, toluene, xylene, quinoline, tetrahydrofuran, naphthalene, acetone, cyclohexane, tetrahydronaphthalene, ether, water, and methyl-pyrrolidinone. When a petroleum or coal tar pitch is used as the carbon-residue-forming material, for example, solvents may include at least one of toluene, xylene, quinoline, tetrahydrofuran, tetrahydronaphthalene and naphthalene. Controlling ratio of the solvent to the carbon-residue-forming material in the solution and temperature of the solution ensures that the carbon-residue-forming material completely or almost completely dissolves into the solvent. In some embodiments, the solvent to carbon-residue-forming material ratio is less than 2, or about 1 or less, and the carbon-residue-forming material is dissolved in the solvent at a temperature that is below the boiling point of the solvent.

For some embodiments, coating of the precursor occurs in a mixture prepared by combining the suspension output from the wet attrition milling with the solution of carbon-residue-forming material. The wet attrition milling blends the precursor with the solvent eliminating need for extra processing in order to prepare the suspension used in creating the mixture in which the carbon-residue-forming material is deposited on the precursor particles. Further, the precipitation occurs in presence of the solvent such that no solvent separation and subsequent drying of the precursor is necessary prior to the suspension output from the wet attrition milling being combined with the solution of carbon-residue-forming material.

Concentrated solutions wherein the solvent to solute ratio is less than about 2:1 are known as flux solutions. Many pitch-type materials form concentrated flux solutions wherein the pitch is soluble when mixed with the solvent at solvent to pitch ratios of 0.5 to 2.0. Dilution of these flux solutions with the same solvent or a solvent in which the carbon-residue-forming material is less soluble results in partial precipitation of the carbon-residue-forming material. When such dilution and hence precipitation occur in presence of the suspension with the precursor that is already milled, the precursor acts as nucleating sites for the precipitation. The precipitation thus results in a uniform coating of the carbon-residue-forming material on the precursor.

The mixture with the coated particles has a ratio in some embodiments of solvent to carbon-residue-forming material of greater than about 2; or greater than about 4. For example, where petroleum or coal tar pitch is chosen as the carbon-residue-forming material and toluene is chosen as the solvent, the ratio of toluene to the pitch may be less than or equal to 1 for the initial solution of the carbon-residue-forming material, but may be greater than 3, or greater than 5, for the mixture with the suspension output from the wet attrition milling combined with the initial solution of the carbon-residue-forming material. Specific ratios of the solvent to carbon-residue-forming material at the conclusion of the precipitation depend on the carbon-forming-residue material and solvent selected. While desirable to use as little solvent as possible due to cost of the solvent, a sufficient quantity of the solvent ensures that the precursor is dispersed in the solvent for the wet attrition milling and the precipitation.

The solubility of the carbon-residue-forming material in a given solvent or combination of solvents depends on a variety of factors including, for example, concentration, temperature, and pressure. Since the solubility of the carbon-residue-forming material in an organic solvent increases with temperature, combining the solution of carbon-residue-forming material and the suspension from the wet attrition milling at an elevated temperature and lowering the temperature during the deposition of the carbon-residue-forming material further enhances the precipitation of the carbon-residue-forming material. In some embodiments, subjecting the mixture to ambient pressure or below ambient pressure and temperatures between about −5° C. and about 400° C. occurs throughout the precipitation of the carbon-residue-forming material. By adjusting the ratios of solvent to the carbon-residue-forming material and the temperature, amount and hardness of the carbon-residue-forming material that is precipitated can be controlled.

Total amount and morphology of the carbon-residue-forming material that precipitates onto the precursor depends on the portion of the carbon-residue-forming material that precipitates out from the solution, which in turn depends on differences in solubility of the carbon-residue-forming material in the initial solution and in the final mixture. When the carbon-residue-forming material is a pitch, a wide range of molecular weight species may be present. Partial precipitation of such a material fractionates the material such that the precipitate is relatively high molecular weight and high melting and the remaining soluble compounds are relatively low molecular weight and low melting compared to the original pitch.

Upon completion of the precipitation, the coated particles are separated from the mixture by solid and liquid phase separation using methods, such as centrifugal separation or filtration. Removal of the solvent from the mixture thus occurs after the precipitation. The particles then are optionally washed with solvent to remove any residual amounts of the carbon-residue-forming material and dried.

Liquid recovered by the separation of the coated particles includes the solvent and possible residual amounts of the carbon-residue-forming material. The solvent can be recovered from the liquid by, for example, distillation under reduced pressure or evaporation at elevated temperature. The solvent recovered in some embodiments feeds back and is reused while the residual of the carbon-residue-forming material is discharged.

For some embodiments, the coating of the precursor is rendered partly or completely infusible by, for example, oxidative stabilization. Subjecting the coated particles to an oxidation reaction using an oxidizing agent under appropriate reaction conditions stabilizes the coating on the precursor. Manner of oxidation depends upon the form of the oxidizing agent utilized, which may be solid, liquid or gaseous under the reaction conditions. The oxidation reaction may be performed by contacting the coated particles with the oxidizing agent at about 20° C. or at temperatures less than about 400° C. In some embodiments, the temperature of the oxidation reaction is maintained below a melting point of the carbon-residue-forming material.

For some embodiments, the stabilized coated particles are subsequently carbonized, and/or graphitized depending on the materials used. When the precursor used to produce the stabilized coated particles is a high-carbon material such as calcined coke, natural graphite or synthetic graphite, the particles can be directly graphitized without an intervening carbonization. Additionally, useful products may be formed by only carbonizing the stabilized coated particles when the precursor is graphite. When the precursor is a softer carbon such as green coke or a soft carbon derived from a natural or synthetic polymer, methods may include carbonizing the stabilized coated particles to a temperature of about 400° C. to about 2000° C. and then graphitizing the particles at a temperature of about 2200° C. or higher. Such heat treating may also result in carbonization/graphitization of the carbon-residue-forming material regardless of composition for the precursor. With regard to atmospheric conditions for the carbonization/graphitization, the atmosphere may be ambient air up to about 850° C. or an inert atmosphere at temperatures above about 400° C. Suitable inert atmospheres include nitrogen, argon, and helium, which are non-reactive with the coated particles.

Some embodiments include forming the coated particles produced from the processes described herein into electrodes (i.e., cathodes or anodes) of electrical storage cells, such as rechargeable batteries. For example, a method for manufacture of an electrical storage cell includes incorporating, into an anode of the electrical storage cell, coated graphitic materials including coated fine, carbonaceous particles having a coating layer formed of an oxidized carbon-residue-forming material.

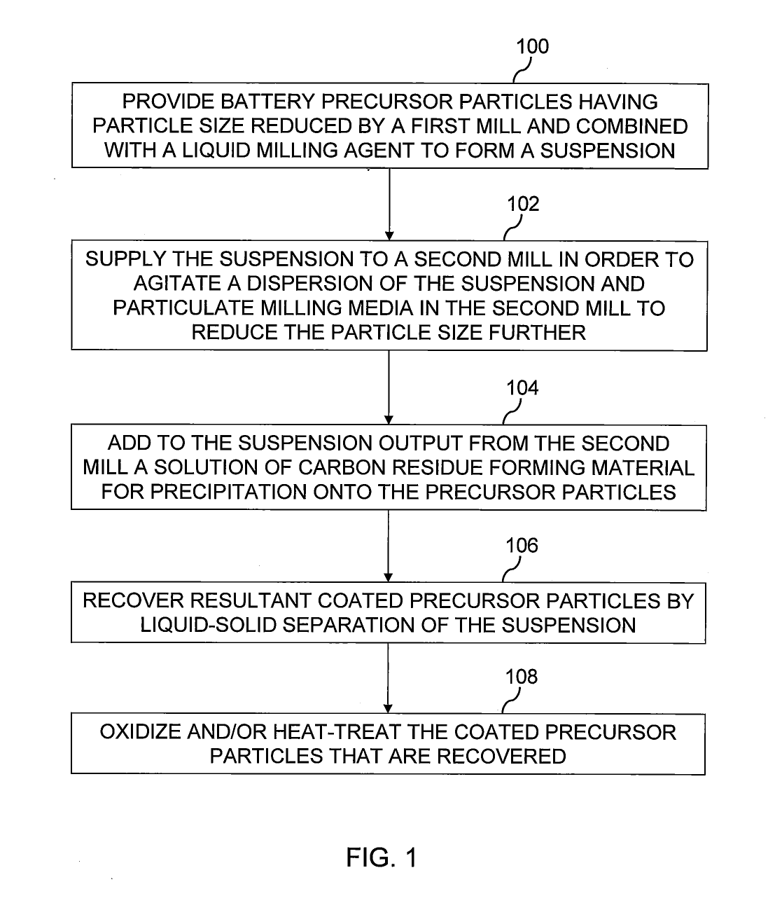

FIG. 1 illustrates a flow chart based on methods described herein of preparing particles for use in batteries. In pre-milling step 100, battery precursor particles having particle size reduced by a first mill combine with a liquid milling agent to form a suspension. Supplying the suspension to a second mill in order to agitate a dispersion of the suspension and particulate milling media in the second mill reduces the particle size further during wet attrition milling step 102. A coating step 104 includes addition of the suspension output from the second mill to a solution of carbon-residue-forming material for precipitation onto the precursor particles. Independent of the coating step 104, recovering resultant coated particles occurs in collection step 106 by liquid-solid separation of the suspension. An optional oxidation and/or heat treatment step 108 stabilizes, carbonizes, and/or graphitizes the coated particles recovered in the collection step 106. Further, the methods in some embodiments include incorporating the coated particles into a battery electrode.

### Examples

Coke was jet milled to provide about 15 micron or 30 micron average particle size. For each test, 2 kilograms of the coke was then combined with 4 liters of xylene to form a suspension. The suspension was supplied at a flow rate equivalent of between about 0.5 kilograms per minute and 1 kilogram per minute to a horizontal disk mill. A milling chamber of the mill included nine disks mounted on a shaft rotated at 1300, 1400 (FIG. 2), 1600 or 1800 revolutions per minute during wet attrition milling in respective ones of the tests. The milling chamber had an internal volume of 4 liters and was 85% filled by milling beads. For particulate milling media, the mill employed the beads made of yttium-stabilized zirconium oxide and having a diameter of about 2 millimeters (mm).

FIG. 2 shows a first curve 200 of particle size distribution after the jet milling alone and a second curve 202 of the particle size distribution following the wet attrition milling. As indicated by the second curve 202, the wet attrition milling resulted in the average particle size being altered to 4.84 micron. The 10^{th} and 90^{th} percentile of the particle size depicted with the second curve 202 was 1.52 micron and 10.29 micron, respectively. Presence of some particles larger than 40 microns even after the wet attrition milling in the test with the coke that was jet milled to 30 micron average particle size indicated that the jet milling was relied on more with respect to controlling of the 90^{th} percentile of the particle size than the wet attrition milling.

FIG. 3 illustrates different relative influences on average and tenth percentile particle dimensions due to agitation speed during the wet attrition milling. When pre-milled by the jet milling, the average size indicated by a first trend line 300 was able to be reduced with the wet attrition milling while relying on the jet milling for change to the 90^{th} percentile of the particle size given that the wet attrition milling may not be as suitable for bulk size reduction. Further, the wet attrition milling altered the average particle size to below 10 microns while creating limited amounts of particles below 1 micron due to less influence by the wet attrition milling on the 10^{th} percentile of the particle size, as depicted by second trend line 302, than the average particle size. In particular, the first trend line 300 slopes as a function of the agitation speed more than the second trend line 302 that remains about flat throughout the agitation speeds tested for the wet attrition milling. Such unexpected relative influences provide ability to utilize tailored dual milling operations to control particle size distributions.

In respective ones of the tests, the suspension output from the wet attrition milling was further mixed with a solution of pitch in xylene while the suspension and the solution were both heated to boiling point of the xylene. A resulting mixture was stirred for about 5 minutes and cooled to about 22° C. while being agitated. Solid particles were filtered out of the mixture, washed with xylene and dried at 90° C. under vacuum. Heating the particles in nitrogen gas and at a temperature reaching 2900° C. resulted in carbonization and graphitization of the particles. The particles were then utilized in coin cells and observed to have electrical charge capacity and ability to be recharged multiple times.

For another test, 167 grams (32% solid content) of the milled slurry that was made under agitation rate of 1700 rpm was mixed with 258 grams of xylene and 79 grams of petroleum refinery decant oil (with a boiling point above 510° C.) in a glass flask and a resulting mixture was heated to 60° C. Subsequently, 16.0 grams of 69% nitric acid was added to the mixture that was then heated to the boiling point of xylene (about 140° C.) and cooled to ambient temperature (about 22° C.). During the above processing steps, a certain portion of the decant oil was oxidized by the nitric acid to form xylene insoluble solid which simultaneously coated on milled particles of coke. Next, solid particles were filtered out of the mixture, washed with xylene and dried at 90° C. under vacuum. The dried powder weighed 66.3 grams, yielding a xylene insoluble solid coating of 19%. Heating the particles in nitrogen gas and at a temperature reaching 2900° C. resulted in carbonization and graphitization of the particles. The particles were then evaluated as anode material in coin cells versus lithium metal and observed to have a specific capacity of 308 mAh/g and initial coulombic efficiency of 93%.

The preferred embodiment of the present invention has been disclosed and illustrated. However, the invention is intended to be as broad as defined in the claims below. Those skilled in the art may be able to study the preferred embodiments and identify other ways to practice the invention that are not exactly as described herein. It is the intent of the inventors that variations and equivalents of the invention are within the scope of the claims below and the description, abstract and drawings are not to be used to limit the scope of the invention.

1. A method comprising:
mixing solid particulate battery material precursor with a liquid milling agent to form a suspension;
agitating a dispersion of the suspension and particulate milling media in a mill to reduce particle size of the solid particulate battery material precursor;
preparing a mixture by adding a solution of carbon-residue-forming material to the suspension output from the mill, wherein the carbon-residue-forming material is precipitated within the mixture onto the solid particulate battery material precursor as a coating prior to solid and liquid phase separation of the mixture to recover coated particles thereby produced; and
heat treating the coated particles to cause carbonization thereof and form products for use in a battery.

2. The method according to claim 1, further comprising introducing into the suspension an organic compound or mixture soluble in the liquid milling agent, wherein the organic compound is present in the suspension while the particle size is being reduced in the mill.

3. The method according to claim 1, further comprising pre-milling the battery material precursor prior to mixing with the liquid milling agent.

4. The method according to claim 1, further comprising jet milling the battery material precursor prior to mixing with the liquid milling agent.

5. The method according to claim 1, wherein the solid particulate battery material precursor includes one of petroleum and coal cokes.

6. The method according to claim 1, wherein the solid particulate battery material precursor includes one of silicon and lithium alloying metals.

7. The method according to claim 1, wherein the solid particulate battery material precursor includes one of lithium metal oxide and lithium metal phosphate.

8. The method according to claim 1, wherein the carbon-residue-forming material includes one of petroleum refinery residues and pyrolysis tars.

9. The method according to claim 1, wherein the solid particulate battery material precursor comprises coke and the carbon-residue-forming material comprises pitch.

10. The method according to claim 1, wherein the liquid milling agent comprises a solvent in common with the solution of the carbon-residue-forming material.

11. The method according to claim 1, wherein the solution of the carbon-residue-forming material comprises pitch dissolved in xylene and the milling agent comprises xylene.

12. The method according to claim 1, wherein the milling agent is an organic solution comprising xylene and xylene soluble heavy hydrocarbons.

13. The method according to claim 1, wherein lowering temperature of the mixture causes the carbon-residue-forming material to be precipitated.

14. The method according to claim 1, wherein concentration dilution of the carbon-residue-forming material causes the carbon-residue-forming material in the mixture to be precipitated.

15. The method according to claim 1, wherein oxidation of the carbon-residue-forming material causes the carbon-residue-forming material in the mixture to be precipitated.

16. The method according to claim 1, further comprising graphitizing the coated particles.

17. The method according to claim 1, further comprising introducing into the suspension a pitch soluble in the liquid milling agent, wherein the pitch is present in the suspension while the particle size is being reduced in the mill and the carbon-residue-forming material comprises additional pitch.

18. The method according to claim 1, wherein the liquid milling agent and a solvent in the solution are both one or more of toluene, benzene, xylene, quinoline, tetrahydrofuran, tetrahydronaphthalene, naphthalene, methanol, acetone, methyl-pyrrolidinone, cyclohexane, and water.

19. A method comprising:
pre-milling coke material into intermediate coke particles;
mixing the intermediate coke particles with xylene to form a suspension;
wet attrition milling the intermediate coke particles into sized coke particles by agitating a dispersion of the suspension and particulate milling media in a mill;
preparing a mixture by adding a solution of pitch dissolved in xylene to the suspension output from the mill, wherein the pitch is precipitated within the mixture as a coating onto the sized coke particles and precipitation of the pitch occurs by diluting concentration of the pitch upon mixing with the suspension and lowering temperature of the mixture from an initial temperature at which the solution and the suspension are combined;
separating solid and liquid phases of the mixture to recover coated particles produced by the precipitation; and
heat treating the coated particles to cause carbonization thereof.

20. The method according to claim 19, further comprising introducing into the suspension additional pitch soluble in the xylene, wherein the additional pitch is present in the suspension during the wet attrition milling.

21. A method comprising:
jet milling carbonaceous material to reduce particle size of the carbonaceous material, thereby providing intermediate sized product;
mixing the intermediate sized product with a liquid milling agent to form a suspension; and
wet attrition milling the intermediate sized product by agitating a dispersion of the suspension and particulate milling media.

22. The method according to claim 21, further comprising introducing into the suspension a pitch soluble in the liquid milling agent, wherein the pitch is present in the suspension during the wet attrition milling.

23. The method according to claim 21, further comprising preparing a mixture by adding a solution of carbon-residue-forming material to the suspension containing sized carbonaceous particles output from the wet attrition milling, wherein the carbon-residue-forming material is precipitated within the mixture onto the sized carbonaceous particles as a coating prior to solid and liquid phase separation of the mixture to recover coated particles thereby produced.
